(19) United States
(12) Patent Application Publication
(10) Pub. No.: US 2005/0087600 A1
(43) Pub. Date: Apr. 28, 2005

(54) Stand alone scanner

(76) Inventor: Yu-Cheng Sheng, Rancho Palos Verdes, CA (US)

Correspondence Address: COUDERT BROTHERS LLP, 333 SOUTH HOPE STREET, 23RD FLOOR, LOS ANGELES, CA, 90071, US

(21) Appl. No.: 10/693,581

(22) Filed: Oct. 23, 2003

(51) Int. Cl. G06K 7/10; G06K 7/14

(52) U.S. Cl. 235/454

(57) ABSTRACT

The present invention provides for a stand-alone scanner capable of sending scanned images to USB (Universal Serial Bus) compliant devices for printing, storage, and transmission without the need of a computer host CPU. One embodiment of the invention is an external USB host that enables existing scanners without USB host functionality to host a variety of USB devices.

### BACKGROUND OF THE INVENTION

1. Field of the Invention

The present invention relates to a scanner comprising a microprocessor; a USB (Universal Serial Bus) host port interface that allows for the scanner to connect directly to USB compliant peripheral devices, and provides the scanner with the ability to be operated independently from a host CPU (Central Processing Unit) and with the ability to communicate with any USB peripheral device connected to the scanner, including sending scanned images to the connected USB peripheral.

2. Description of the Prior Art

Stand alone, flatbed scanners are known. However, it is not known to include a USB host CPU that is capable of processing, sending and/or receiving signals via USB interfaces that are described herein as incorporated in a flatbed scanner.

### OBJECTS AND SUMMARY OF THE INVENTION

It is an object of the present invention to provide a scanner that comprises an USB host port that enables the scanner to send scanned images to an external USB peripheral device without the need for connecting the scanner to a CPU host.

It is an object of the present invention to provide an external USB host port, wherein said USB host port can plug into a scanner with a default USB device interface, to enable the scanner to communicate with an external USB peripheral device without the need for connecting the scanner to a CPU host.

### BRIEF DESCRIPTION OF THE DRAWINGS

FIG. 1A is a perspective view of a first preferred scanner embodiment of the present invention.

FIG. 1B is a perspective view of a second preferred scanner embodiment of the present invention.

FIG. 1C is a perspective view of a third preferred scanner embodiment of the present invention.

FIG. 2 depicts the back of a stand-alone scanner and various USB devices that can be connected to the scanner in accordance to the present invention.

FIG. 3 is a block schematic diagram of an embodiment of the present invention.

FIG. 4 depicts the back of a scanner with an external USB host port connected to the scanner.

FIG. 5 depicts the back of a scanner with an external USB host port connected to the scanner, wherein the external USB host port has an additional external power supply source.

FIG. 6 is a block schematic diagram of an embodiment of the external USB host port and how it connects to a scanner and other USB peripheral devices.

### DESCRIPTION OF PREFERRED EMBODIMENTS

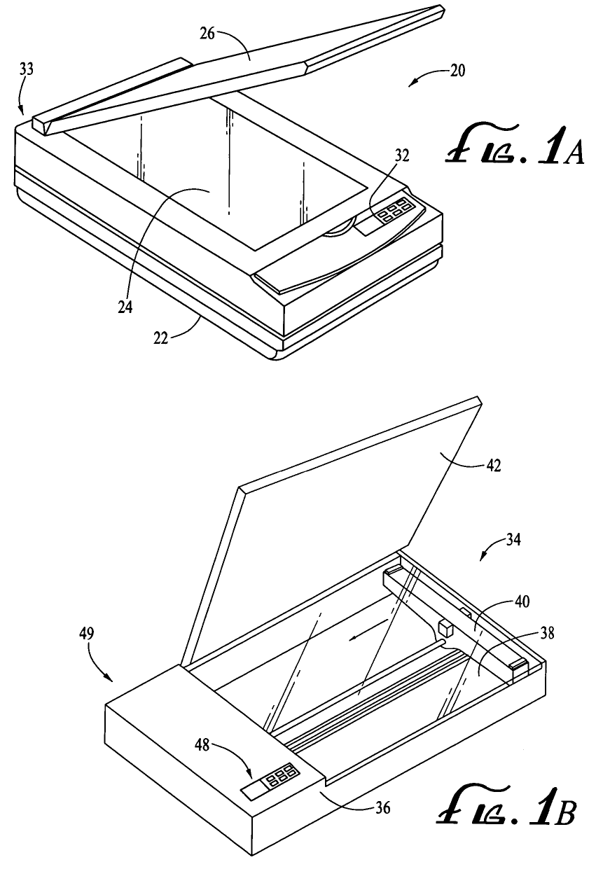

Referring to FIGS. 1A to 6, several preferred embodiments of the present invention will be described. The present invention is directed to stand-alone, computer peripheral scanners, which are capable of scanning operations independent from a host CPU and hosting other USB peripheral devices.

Referring to FIG. 1A, a first preferred embodiment of the present invention is shown, including a conventional CCD-type flatbed scanner 20, housing 22, glass platen 24 and hinged lid 26. Also shown on the scanner housing is control panel 32, which is used to control the operation of the scanner. A USB host port 33 (not shown) is at the back of the scanner 20, allowing USB devices to be connected to scanner 20. It will be appreciated that the location of the USB host port 33 can be anywhere on the scanner to provide convenient access to the user of the scanner and/or most efficient use of space within the housing 22. USB host port 33 differs from USB interfaces commonly found in conventional scanners. Whereas conventional USB interfaces in a scanner allow it to connect to a USB host in a CPU, the USB host port 33 allows other USB compliant peripheral devices to be attached to and communicate with the scanner, and for the scanner to direct data signal to these peripherals independent of an associated computer's CPU. Thus the scanner of the present invention is a stand-alone scanner with respect to USB peripheral devices. Control panel 32 can be used to control the operation of scanner 20, including the task of sending scanned images to an USB device attached to scanner 20 via USB host port 33.

Referring to FIG. 1B, a second preferred embodiment of the invention is shown adapted for use in a “CIS” (Contact Image Sensor) type scanner 34. The scanner 34 includes a housing 36, glass platen 38, hinged cover 42, and a CIS scanner positioned on a carriage 40. A CIS scanner is described in commonly owned U.S. Pat. No. 5,907,413, incorporated by reference as if set forth fully herein. A USB host port 49 (not shown) is at the back of the scanner 34, allowing USB devices to be connected to scanner 34. It will be appreciated that the location of the USB host port 33 can be nearly anywhere on the scanner housing to provide convenient access to the user of the scanner and/or most efficient use of space within the housing 36. Control panel 48 can be used to control the operation of scanner 34, including the task of sending scanned images to an USB device attached to scanner 34 via USB host port 49.

Referring to FIG. 1C, a third preferred embodiment is shown, including a conventional transmissive/reflective type scanner 50, a housing 52, reflective scanning platen 56 and a transparency holder 54. This type of transmissive/reflective scanner is of the type disclosed in commonly owned U.S. Pat. Nos. 5,705,805, 5,814,809, and 5,574,274. The housing 52 includes a control panel 60 which includes a liquid crystal display (“LCD”) and a multi-function control button 64. A USB host port 65 (not shown) is at the back of the scanner 50, allowing USB devices to be connected to the scanner 50. It will be appreciated that the location of the USB host port 65 can be nearly anywhere on the scanner housing to provide convenient access to the user of the scanner and/or most efficient use of space within the housing 52. Control panel 60 can be used to control the operation of scanner 50, including the task of sending scanned images to an USB device attached to scanner 50 via USB host port 65.

Referring to FIGS. 1A through 1C above, the various embodiments of the present invention provide for reflective or transmissive scanning, and flatbed or handheld scanning, as is conventional. However, the present invention also provides for transfer of the digital data representative of each scanned image directly to any USB device that is attached to a scanner embodiment of the present invention through a built-in USB host port. Alternatively, for an existing scanner without a build-in USB host port, an external USB host port is attached to such a scanner, thus providing the scanner with the additional capability of sending digital data representative of each scanned image directly to any USB device connected to the external USB host port.

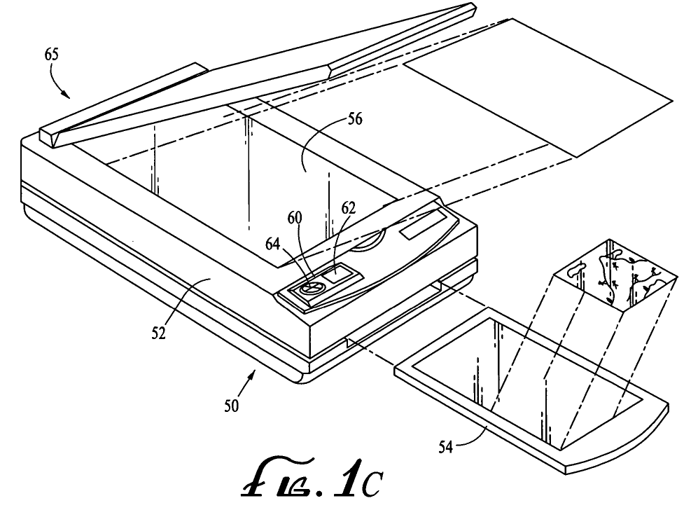

FIG. 2 is a view of a back of a scanner embodiment of the present invention. Scanner 70 comprises of an USB host connection 72. Through USB host port 72 a variety of USB peripheral devices can be connected directly to the scanner. For example, a USB compliant printer 74 may be connected to scanner 70, allowing a scanned image to be printed directly to printer 74 without the need of a computer host CPU. In another example, a USB compliant memory card reader 76 can be connected to scanner 70, allowing scanned images to be stored directly onto a memory card residing inside memory card reader 76 without the need of a computer host CPU. In yet another example, a floppy drive 78 can be connected to scanner 70, allowing scanned images to be stored directly to a floppy inside floppy drive 78 without the need of a computer host CPU. Furthermore, a USB network adaptor 80 may be used to connect scanner 70 to a network, allowing the scanner 70 to be accessed remotely. Scanned images in scanner 70 may thus be sent directly to other devices and/or computers within the network. With the network connection, scanner sharing becomes possible. For example, the scanner can be programmed to send scanned image files to a remote file server, where users can access these files. Also the scanner can send images via emails to many different addresses.

In yet another USB device example, a portable USB storage device 82 may be connected directly to scanner 70 via USB host port 72, allowing scanned images to be stored onto the portable USB storage device 82 directly without the need of a computer host CPU. If so desired, scanner 70 can still be connected to a computer CPU 84 via USB device interface 86, in which case the scanner can either receive instruction from the CPU 84 for scanning operations, and/or send scanned images to CPU 84 for storage.

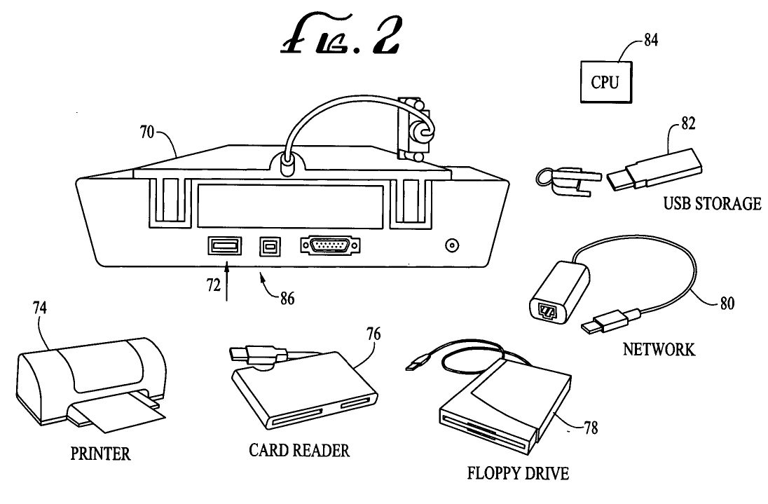

FIG. 3 is a block diagram detailing the internal layout of one embodiment of the present invention. This depicted internal layout is also applicable to scanner 20, scanner 34, or any other scanner employing the same principle functionalities. In one embodiment, USB host controller 71 can be the CY7C67300 controller manufactured by Cypress Semiconductor Corporation of San Jose, Calif. As the CY7C67300 controller is manufactured in compliance to the USB-On-The-Go specification, other comparable chips/controllers that conform to the same specification can be employed in the present invention. The CY7C67300 controller comprises an internal RISC microprocessor 73, which allows for the USB host controller 71 to function as a stand-alone processor, or as a co-processor to the processor on the scanner control board 88. Though not shown in FIG. 3, the CY7C67300 controller also comprises an interface with memory storage, a shared input and output interface, and a plurality of USB interfaces. In one preferred embodiment, USB host interface is connected to the scanner controller board 88, enabling communication between the USB host controller 71 and the scanner controller board 88. The power required by the USB host controller 71 is provided by the scanner 70 power source.

The USB host controller 71 can operate in two modes simultaneously: a host mode and a peripheral mode. In the host mode, USB host controller 71 acts as an USB host. Scanner controller board 88 would reply signals representing scanned image information to the USB host controller 71, which would in turn direct such signals to a USB peripheral connected at USB host port 72 for the purposes of storage, printing, etc. The USB host controller 71 would also communicate with the attached USB peripheral devices in accordance to the USB standard. For example, USB host controller 71 may send USB print commands to an attached printer.

When the USB host controller 71 is operating in the peripheral mode, the scanner operates as a conventional USB peripheral device, as defined by the USB standard. The USB host controller 71 would perform communication defined by the USB standard with an external host and pass those signals to the scanner controller board 88. For example, a CPU may send scanning instructions via USB device port 86 to USB host controller 71, which relays the instructions to scanner controller board 88.

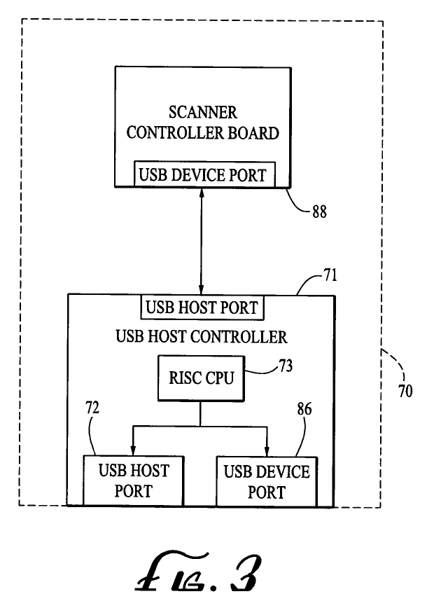

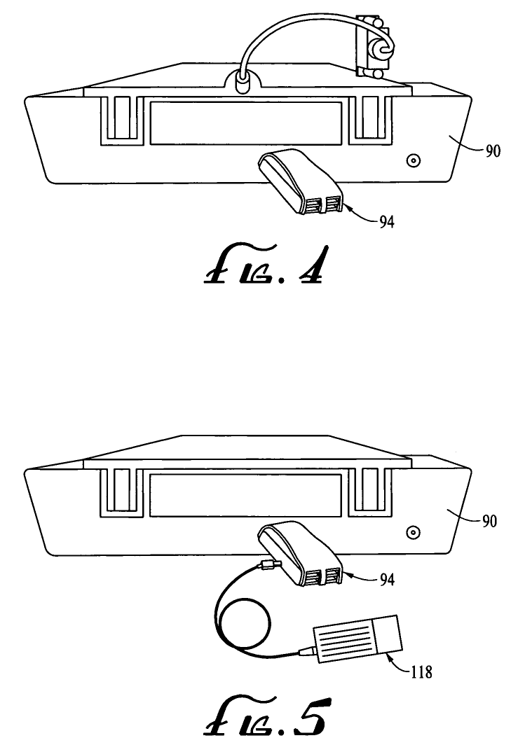

FIG. 4 shows another preferred embodiment of the present invention in which USB host 94 is external to scanner 90. In this embodiment, scanner 90 is a scanner without internal USB host functionality. An external USB host port 94 is shown to be attached to scanner 90 via the ADF (Auto Document Feeder) interface and USB device interface in scanner 90. The ADF interface of scanner 90 (not shown) provides power to USB host 94. The external USB host 94 can host multiple USB devices. As before, printers, memory card readers, and other USB compliant devices may be plugged into external USB host 94, allowing the scanner to operate directly with these USB devices without the need of a computer's CPU. USB host 94 draws power from the scanner via the ADF interface. If a scanner does not have an ADF interface, an external power supply is used to supply power to USB host 94. FIG. 5 shows another embodiment of an external host 94 with an external power source 118 supplying the power required for operation.

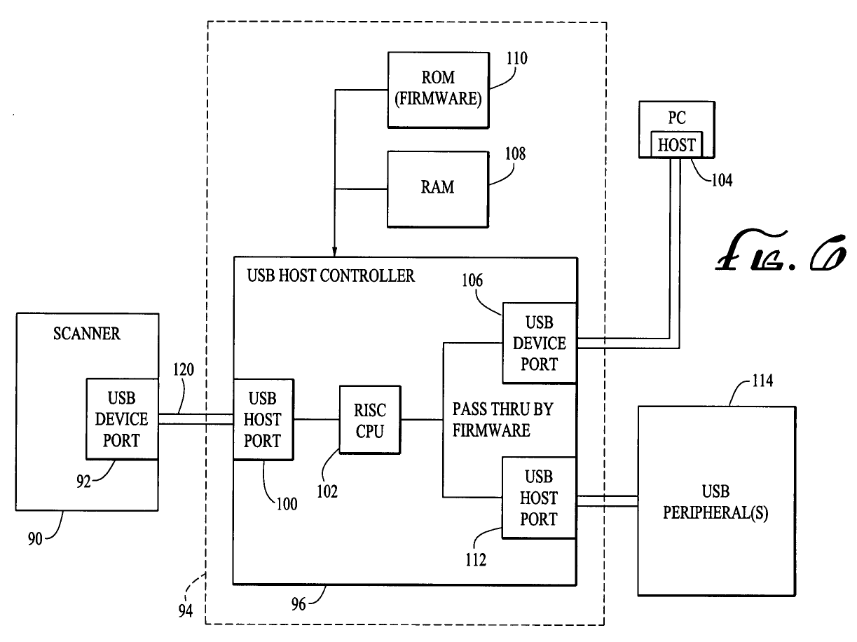

FIG. 6 is a block diagram depicting the internal components of the preferred embodiment of FIGS. 4 and 5. Scanner 90 comprises of USB device port 92, with is connected via a USB cable 120 to USB host port 100 of USB host 94. USB host 94 is external to scanner 90 and the components of the host are encapsulated in a housing (defined by the dotted line in the figure). USB host 94 includes a USB host controller 96, such as the CY7C67300 manufactured by Cypress Semiconductor Corporation, ROM 110 and RAM 108. Firmware is preferably written on ROM 110 to control the operation of USB host controller 96. A pass through capability is implemented in the firmware. The pass through allows a host computer 104, if connected, to access the USB peripheral(s) 114. For example, the host computer may want to read from a USB card reader connected to USB host 94, or print to a USB printer connected to USB host 94. Note that multiple USB peripherals 114 can be attached to USB host 94. Thus USB host 94 can act as a USB hub and pass the USB communication between host computer 104 and USB peripheral device 114. In one embodiment, USB host controller 96 includes a first USB host port 100 for interfacing with scanner 90, a RISC-based CPU 102 (48 MHz), a USB device port 106 for interfacing with a PC host 104, a second USB host port 112 for interfacing with a plurality of USB devices 114. USB device(s) 114 can be any USB peripheral, for example, a USB drive, a USB card reader, a USB printer, a USB Ethernet connection, etc. Scanner 90, if equipped with an ADF (Auto Document Feeder) port, would supply power to USB host 94 via the USB cable 120. In an alternate embodiment, for a scanner 90 without an ADF port, USB host port 94 would require an external power source 118, as shown in FIG. 5. Furthermore, the control panel status of the scanner (e.g. the user pressing the scan button on the control panel) can be known via USB commands that retrieve the status of the control panel. For example, USB host 94 would repeatedly query scanner 90 for the status of the control panel via USB connection 120. If a button has been pressed, USB host controller 94 will send read image commands for starting the scan job and rendering the image data for printing or storage to the USB peripheral(s) 114.

It will be understood that certain features and subcombinations are of utility and may be employed without reference to other features and subcombinations as they are outlined within the description above and within the claims appended thereto. While the preferred embodiments and application of the invention have been described, it is apparent to those skilled in the art that the objects and features of the present invention are only limited set forth in the claims appended hereto.

1. A stand alone scanner comprising:
a USB host controller;
the USB host controller including a USB host port adapted to permit said scanner to communicate with a peripheral USB device connected to said scanner at said USB host port, without the need of a host CPU connected to said scanner; and
the USB host port adapted to permit said scanner to send data signal representative of scanned images to said peripheral USB device.

2. The stand alone scanner of claim 1 wherein said USB host controller is a CY7C67300 controller manufactured by Cypress Semiconductor Corporation.

3. The stand alone scanner of claim 1 wherein said peripheral USB device is a printer.

4. The stand alone scanner of claim 1 wherein said peripheral USB device is a memory card reader.

5. The stand alone scanner of claim 1 wherein said peripheral USB device is a USB network interface.

6. The stand alone scanner of claim 1 wherein said peripheral USB device is a USB media storage device.

7. A USB host, comprising:
a housing;
an USB host controller external to a scanner, positioned within said housing, and adapted to communicate with the scanner;
a first USB host port adapted to communicate with a USB device port of the scanner;
a second USB host port adapted to communicate with a USB peripheral device, whereby said external USB host enables said USB peripheral device to communicate with said scanner.

8. The external USB host of claim 7, further comprising:
a external power supply connected to said external USB host.

9. The external USB host of claim 7, wherein said second USB host port is adapted to communicate with more than one USB peripherals.

10. The external USB host of claim 7, wherein said USB host controller a CY7C67300 controller.
